(19) United States
(12) Patent Application Publication
(10) Pub. No.: US 2019/0225339 A1
(43) Pub. Date: Jul. 25, 2019

(54) ENHANCED LOWER DECK COMMERCIAL CABINS

(71) Applicant: Zodiac Aerospace S.A., Plaisir (FR)

(72) Inventors: Ramon Blauwhoff, Leimuiden (NL); Yannick Brunaux, Croix (FR); Sebastien Sivignon, Brax (FR)

(21) Appl. No.: 16/330,200

(22) PCT Filed: Nov. 22, 2016
(86) PCT No.: PCT/IB2016/057048

§ 371 Date: Mar. 4, 2019

Related U.S. Application Data
(60) Provisional application No. 62/378,951, filed on Aug. 24, 2016.
(60) Provisional application No. 62/378,957, filed on Aug. 24, 2016.
(60) Provisional application No. 62/394,906, filed on Sep. 15, 2016.

(51) Int. Cl. B64D 11/04; B64C 1/00

(52) U.S. Cl. CPC B64D 11/04; B64C 2001/0027; B64C 1/00

(57) ABSTRACT

Alternate manners of utilizing areas of, principally, cargo areas of commercial passenger aircraft are described. These manners of utilizing preferably occur during cruise or other non-TTL portions of flight and provide passengers with additional opportunities to move, shop, meet, relax, bathe, exercise, cook, eat, work, or otherwise engage in activities conventionally unavailable or difficult to perform while on-board commercial aircraft. They likewise may provide opportunities to generate additional revenue from passengers without necessarily adding seats. Equipment and structures permitting these uses of the cargo areas as lower deck cabins also are detailed.

### CROSS-REFERENCE TO RELATED APPLICATIONS

This application claims the benefit of and priority to each of
(1) U.S. Provisional Patent Application Ser. No. 62/378,951, filed Aug. 24, 2016, entitled “Automated Shelf Insurance,”
(2) U.S. Provisional Patent Application Ser. No. 62/378,957, filed Aug. 24, 2016, entitled “Lower Deck Modular System Including Bench, Table and/or Shelf,” and
(3) U.S. Provisional Patent Application Ser. No. 62/394,906, filed Sep. 15, 2016, entitled “Spatial Arrangements for a Lower Deck Commercial Cabin in Widebody A/C,”
   the entire contents of all of which are incorporated herein by this reference.

### FIELD OF THE INVENTION

The present invention relates generally to enhancements of space extant below passenger decks, also designated as “main” decks, of, principally, commercial passenger aircraft. Conventionally, such space is used for the transport of cargo or is unused if insufficient cargo is available for transport. Embodiments of the invention may allow pre-flight conversion of the otherwise-unused space extant below passenger decks into areas available for use by passengers primarily, but not necessarily exclusively, during cruise portions of an aircraft flight.

### BACKGROUND OF THE INVENTION

Commercial passenger aircraft may transport passengers over long distances. Many of these aircraft are configured with at least one “main” deck having a floor to which arrays of passenger seats are directly or indirectly secured to form a passenger cabin. Some commercial aircrafts, such as the Airbus A380 series aircraft or the Boeing 747 series aircraft, contain two main decks arranged one above the other.

Convention and governmental regulations require passengers to be restrained in the seats of these main decks during specific flight phases of the aircraft, mainly during taxi, take-off, and landing (also designated by the acronym “TTL”) phases, and at times when commanded by the aircraft flight crew. At other times, including during the cruise portion of a flight, however, passengers need not be restrained in their seats, and, instead, may move about in passenger cabins bounded by the main decks.

Also typically present in commercial aircrafts is a cargo area positioned below the main deck. The cargo area is also often positioned in an area of an aircraft fuselage below a plane formed by the fixed portions of the wings, although this is not necessarily true for all aircrafts. Regardless of its placement, the cargo area defines one or more areas available conventionally to transport cargo during an aircraft flight. Thus, in general terms, the cargo area of an aircraft may be considered to be or to include areas below the lowest floor of the passenger cabins of the aircraft, according to a conventional vertical direction of the aircraft.

For some flights, insufficient monetary incentive exists for flight operators to transport cargo, or insufficient cargo exists to fill the designated cargo areas arranged below main decks. This is especially, although not exclusively, true for some long-haul routes with substantial passenger demand, as large, wide-body aircrafts may be employed with great frequency to meet the passenger transport need. These flights thus often travel with cargo areas being vacant, resulting in waste of that space for each entire flight.

International Patent Application Publication No. WO 2015/181801 (hereinafter “WO 2015/181801”) details various opportunities to use these otherwise-wasted cargo areas. In particular, WO 2015/181801 contemplates utilizing the cargo areas for additional passenger seating during various flight phases, e.g. during TTL phases. Accordingly, it addresses issues to create a lower deck, arranged in the cargo area, in which passengers may stand, providing stairs for ingress into and egress from the lower deck, and projecting or simulating views from outside the aircraft to account for a lack of windows in the lower deck. Also mentioned in WO 2015/181801, is the possibility of placing vending machines in the lower deck to allow passengers seated in the lower deck to select beverages, snacks, and meals for consumption while on-board the aircraft without having to access the main deck. In addition, WO 2015/181801 addresses issues to create a lower deck while lowering technical floors of the cargo area in which passengers may stand.

Affixing additional passenger seats in the lower deck of an aircraft presents opportunities for airlines to expand the proceeds produced for any particular flight by changing the otherwise-wasted cargo areas into a revenue-generating passenger space. However, utilizing the lower deck for passenger seating adequate to comply with TTL phases requirements essentially precludes the space from being used for any other material purpose. Consequently, airlines desiring not to add passenger seats in the lower deck will continue to face challenges in avoiding waste of the space when cargo is unavailable or insufficient to fill it.

### SUMMARY OF THE INVENTION

Versions of the invention disclosed herein seek to supply alternate manners of utilizing areas of lower decks of an aircraft. Although these manners of utilization preferably occur during cruise portions of flight, i.e. non-TTL phases, in certain situations they may be employed during TTL phases as well. Often, they may provide airlines, and perhaps others, with opportunities to generate additional revenue from passengers without necessarily adding seats. At the same time, they may provide passengers with additional opportunities to move, shop, meet, relax, bathe, exercise, cook, eat, work, or otherwise engage in activities conventionally unavailable or difficult to perform while on-board a commercial aircraft.

Numerous changes to the lower deck potentially may occur consistent with the invention. Benches, tables and/or shelves, for example, as well as individual seats, may be added to transform a lower deck space into a passenger cabin comprising any or all of retail stores, meeting rooms, restaurants, etc. Embodiments of these components could be movable, moreover, folding flat against walls, for example, when not in use. They also could be securable so as not to move during turbulent flying conditions or other than when desired.

In some embodiments of the invention, areas of the lower deck are transformed into shops. In these areas, tables and shelves may be used to display wares for examination or purchase, and benches and/or seats may be used by passengers desiring to examine the wares. The benches and/or seats may include seat belts and/or other restraints intended to mitigate adverse effects of turbulence on the seating passengers. Passenger service units (also designated as “PSUs”), which may comprise emergency oxygen supplies, may be located in the vicinities of the benches and seats as well.

Displayed wares may be secured to walls, tables, shelves and/or otherwise within the shops. Certain versions of the invention allow wares to be restrained within shelving units, as by covering the units, for example. Restraint actions, furthermore, may be performed manually by crew members and/or shop personnel, for example, and/or may be automated. In the latter circumstance, movement of a restraint may be actuated electrically based on information sent via a communication system of an aircraft as, for instance, when a pilot and/or other crew member believes the aircraft is approaching turbulent conditions and/or is preparing for TTL phases.

Monuments, which may be in the form of vertical dividers and/or doors, may, if desired, transform portions of the lower deck into rooms for meeting, sleeping and/or otherwise. Benches, tables, shelves and/or seats, as discussed above, may, if available, be used in support of passenger meetings and/or rest. PSUs likewise may be located within the rooms.

Any or all of the equipment and/or assemblies thereof may be modular for uniformity, ease of installation and/or removal, or otherwise. Likewise, standardized and/or modular fittings may be located on walls, floors and/or ceilings of the lower deck to which the equipment and/or assemblies may connect.

Additionally contemplated are changes to the lower deck discussed in WO 2015/181801. As an example, lowering of the technical floor of the lower deck in some areas may be necessary to provide adequate standing room for passengers. Stairs or other means for accessing the lower deck also may be needed. Such stairs, if present, preferably span the main deck and the lower deck both to allow passage therebetween and to assist in passenger evacuation from the lower deck, if ever needed.

Other features and advantages of the invention will be apparent with reference to the remaining text and the drawings of this application. Both the descriptive text and the drawings are provided for illustrative purposes and not to restrict any of the inventive concepts detailed or depicted herein. Instead, such concepts may be interpreted as broadly as permitted under applicable law and practice.

### BRIEF DESCRIPTION OF THE DRAWINGS

FIG. 1 is a schematized, generally side elevational view of an aircraft illustrating exemplary positioning of various cargo compartments.

FIG. 2 is a schematized, generally side elevational view of aspects of the forward cargo compartment of FIG. 1.

FIG. 3 is a schematized, generally side elevational view of aspects of the aft cargo compartment of FIG. 1.

FIG. 4 is a schematized, generally side elevational view of a first proposed lay-out of a shop in a lower deck of the aircraft of FIG. 1.

FIG. 5 is a schematized, generally side elevational view of a second proposed lay-out of a shop in a lower deck of the aircraft of FIG. 1.

FIG. 6 is a schematized, generally side elevational view of a first proposed lay-out of a meeting room in a lower deck of the aircraft of FIG. 1.

FIG. 7 is a schematized, generally side elevational view of a second proposed lay-out of a meeting room in a lower deck of the aircraft of FIG. 1.

FIG. 8 is a schematized, generally partial side elevational view of shelving, in a closed position, useful especially as part of the shops of FIGS. 4-5.

FIG. 9 is a schematized, generally side elevational view of shelving, some of which is in an open position, useful especially as part of the shops of FIGS. 4-5.

FIG. 10 is a schematized, generally side elevational view of an unfolded seat useful especially as part of the shops or meeting rooms of FIGS. 4-7.

FIG. 11 is a schematized, generally side elevational view of an unfolded desk or table useful especially as part of the shops or meeting rooms of FIGS. 4-7.

FIGS. 12-17 are schematized depictions of exemplary restraint mechanisms for wares which may be controlled via the communications or actions of FIG. 13.

FIG. 18 is a flow chart of exemplary communications or actions that may change the state of (e.g. open/close) a restraint mechanism of FIGS. 12-17.

FIG. 19 is a schematized view of a passenger seat which may be controlled via the communications or actions of FIG. 18.

FIG. 20 is a sample lay-out of passenger accommodations (also designated as “LOPA”) on a main deck of the aircraft of FIG. 1 illustrating possible placements of stairs allowing access to the lower deck.

FIG. 21 schematically depicts various configurations of stairs whose placements are illustrated in FIG. 20.

In the above-identified figures, structural and functional elements which are common to different embodiments may have the same reference. Thus, unless otherwise stated, such elements may have identical structural, dimensional, and material properties.

### DETAILED DESCRIPTION

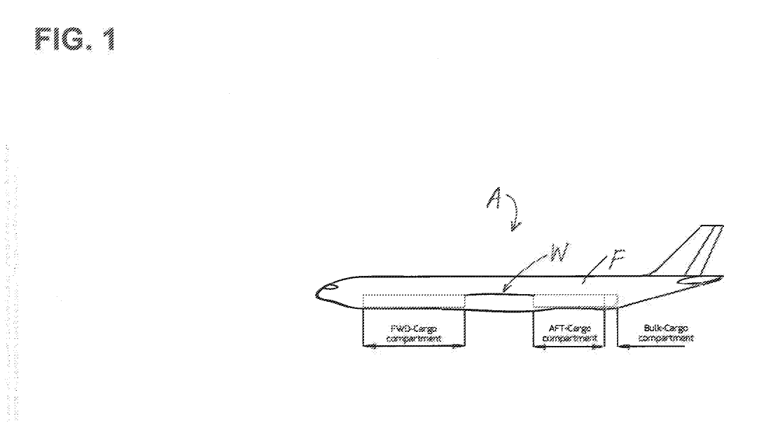

Shown in FIG. 1 are portions of an aircraft A. As depicted, the aircraft A may be a fixed-wing airplane suitable for transporting at least commercial passengers, i.e. passengers having paid their tickets (in currency or otherwise) for travelling—as opposed to crew members, including pilots and cabin crew members, also known as stewards/stewardesses, air hosts/hostesses and flight/cabin attendants, and cargo by air. Examples of the aircraft A may be wide-body airplanes, such as the Airbus A340 series aircraft or the Boeing 767 series aircraft, although the present invention is usefully employed with other types of airplanes as well.

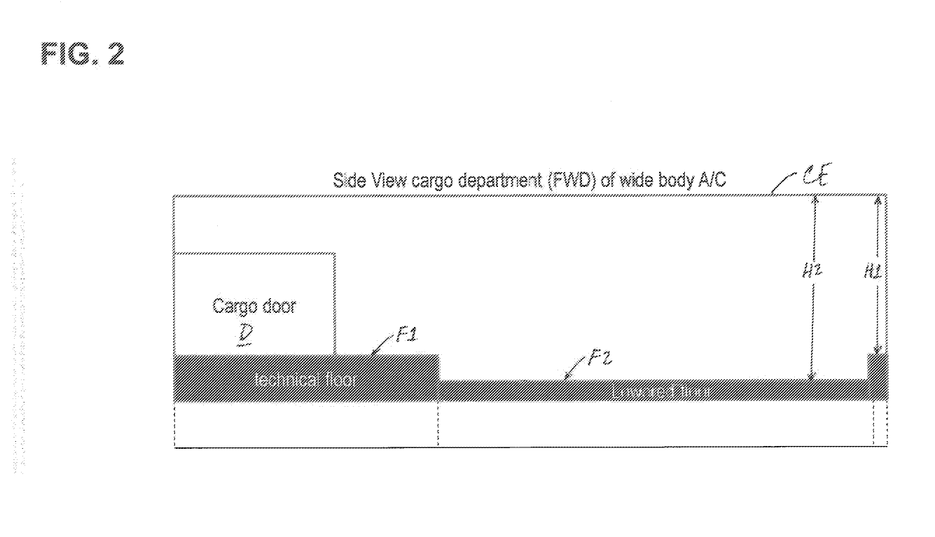

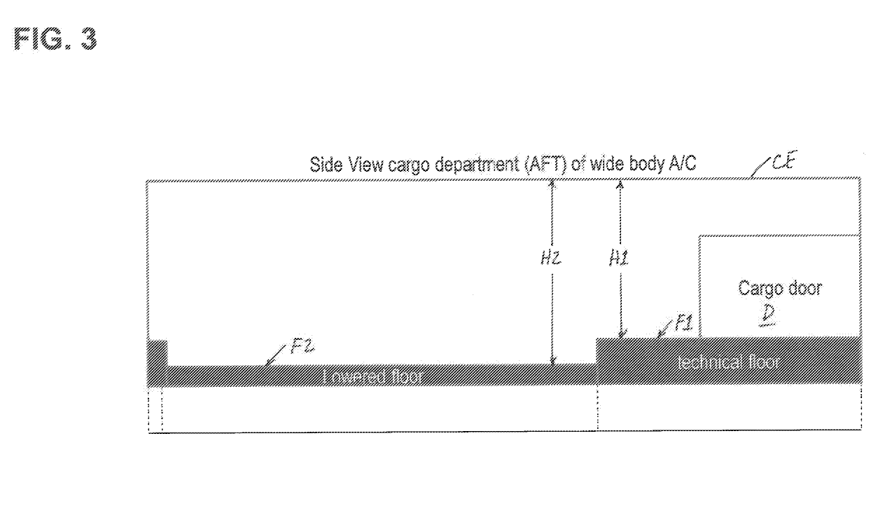

The aircraft A may include a fuselage F defining an interior space defined therein. The aircraft A may also include at least a wing W, which schematically forms a generally horizontal plane projecting out of the sheet on which FIG. 1 appears. In ordinary use of the aircraft A, in a vertical direction according to a standard use of the aircraft A, positioned below this generally horizontal plane and to the fore and/or aft of the wing W are areas typically used to transport cargo. FIG. 2 illustrates a front cargo area FWD that is forward of the wing W, as determined by a conventional direction of ordinary travel of aircraft A, whereas FIG. 3 illustrates a rear cargo area AFT that is aft of the wing W. The front cargo area FWD and/or the rear cargo area AFT may be accessed from the exterior of the aircraft A using at least one door D in its fuselage F. Conventionally, cargo is loaded into and unloaded from the front cargo area FWD and/or the rear cargo area AFT via the door D. The front cargo area FWD, respectively the rear cargo area AFT, is additionally furnished with a technical floor F1 onto which cargo may be loaded.

The technical floor F1 may be positioned at a first vertical distance H1 from a ceiling CE of the front cargo area FWD and/or the rear cargo area AFT. The ceiling CE may be the underside of a partition floor forming the lowermost main deck of the aircraft A, or it may be some other roof or boundary.

The first vertical distance H1 is generally insufficient to allow many persons to stand fully upright on the technical floor F1. Consequently, if the front cargo area FWD and/or the rear cargo area AFT is to be used as a lower deck cabin for in-flight activities during which passengers desire to stand upright, the first vertical distance H1 needs to be enlarged.

One approach to doing so involves lowering the technical floor F1 to a lower level so as to define a lowered floor F2. Alternatively, it may involve decreasing the thickness of the technical floor F1 to define a lowered floor F2.

With these approaches, a greater second vertical distance H2 exists between the lowered floor F2 and the ceiling CE. By contrast with the first vertical distance H1, the second vertical distance H2 of this modified cargo area may be sufficiently large to allow at least most, if not all, passengers and crew to stand upright on and/or move about the lowered floor F2.

In some embodiments, the lowered floor F2 may extend the entire length of cargo areas such as the front cargo area FWD and/or the rear cargo area AFT.

Alternatively, as illustrated in FIGS. 2-3, the technical floor F1 and the lowered floor F2 may, if desired, co-exist within the front cargo area FWD and/or the rear cargo area AFT. This co-existence may occur when some cargo will be transported and need to be supported by the technical floor F1.

Alternatively, the co-existence may be appropriate for structural reasons so as to cooperate with existing frames around, e.g., doors D or existing components of a wingbox of the wing W.

Even if only the first vertical distance H1 exists in part of the front cargo area FWD and/or the rear cargo area AFT, that part of the area may be used to place monuments and/or equipment not requiring passengers or crew to stand as, for example, sitting or sleeping arrangements.

As noted here-above, for some flights of the aircraft A, insufficient cargo may be available to fill either or both of the front cargo area FWD and/or the rear cargo area AFT. Alternatively, the operator of the flight may elect not to transport available cargo in portions or all of the front cargo area FWD and/or the rear cargo area AFT. In either situation, either or both of the front cargo area FWD and/or the rear cargo area AFT may be repurposed and used instead for activities other than transportation of cargo.

Non-limiting examples of such conversions include using the areas for meeting rooms, retail shops, restaurants, casinos or gaming zones, theaters or cinemas, pet interaction areas, libraries, virtual reality areas, sports venues, product presentation areas, kitchens, stowage areas, bars, clubs, or lounges, swimming pools, saunas, or spas, religious areas, gymnasiums or fitness zones, laundries, auction houses, living areas, work spaces, showers or bathrooms, pop-up stores, or other passenger accommodations, whether separately or in any combination.

Such areas of the front cargo area FWD and/or the rear cargo area AFT, and of any other cargo area that may be present in an aircraft, converted for human uses by passengers and, possibly, crew may create one or more “lower deck cabins” in the aircraft A.

Conversions of cargo areas into lower deck cabins may be permanent or temporary as they relate to a particular aircraft A. Because they preferably are modular, monuments and/or other equipment added during a conversion, for example, may be quickly and easily removed if a lower deck cabin is to be returned to being a cargo area.

If suitably configured, the lowered floor F2 may be raised to return to the technical floor F1. Alternatively, the lowered floor F2 may be covered by a further floor, which may be for instance a spacer or pallet, to add to its thickness and thus return a front cargo area FWD and/or a rear cargo area AFT to having a first vertical distance H1 between the flooring and its ceiling CE.

Yet alternatively, a lower deck cabin may be created as an integral structure loaded into the aircraft A similar to a conventional cargo container and connected to suitable fittings (e.g. power, water, waste, etc.) for use.

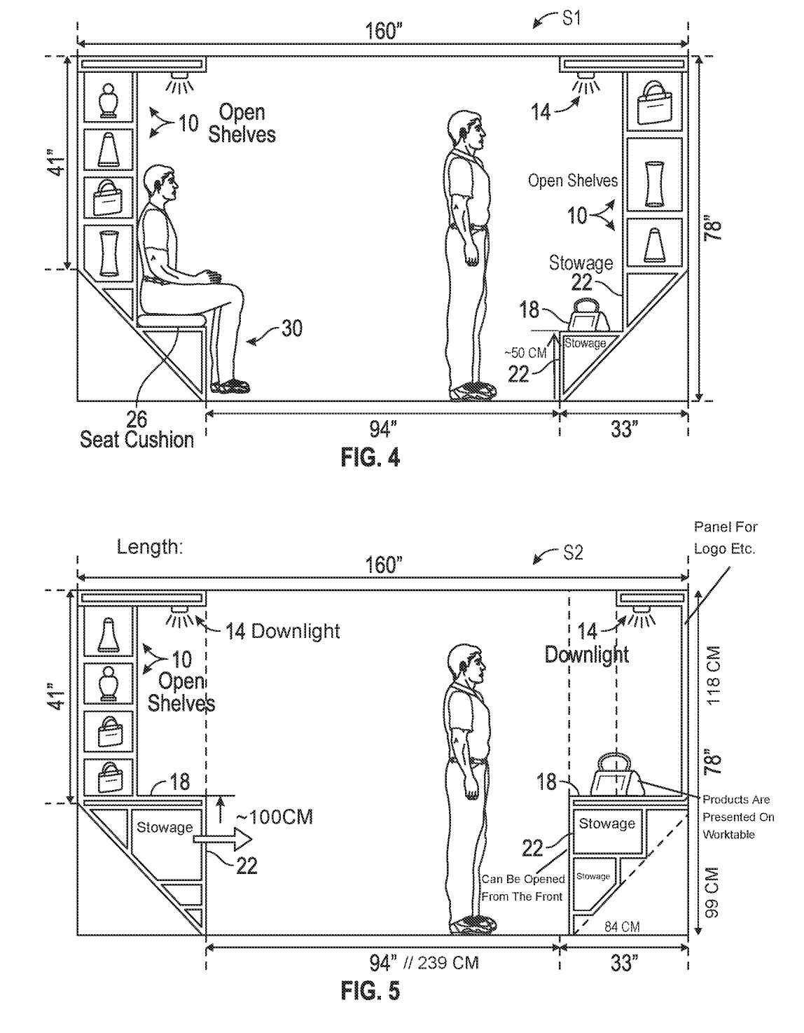

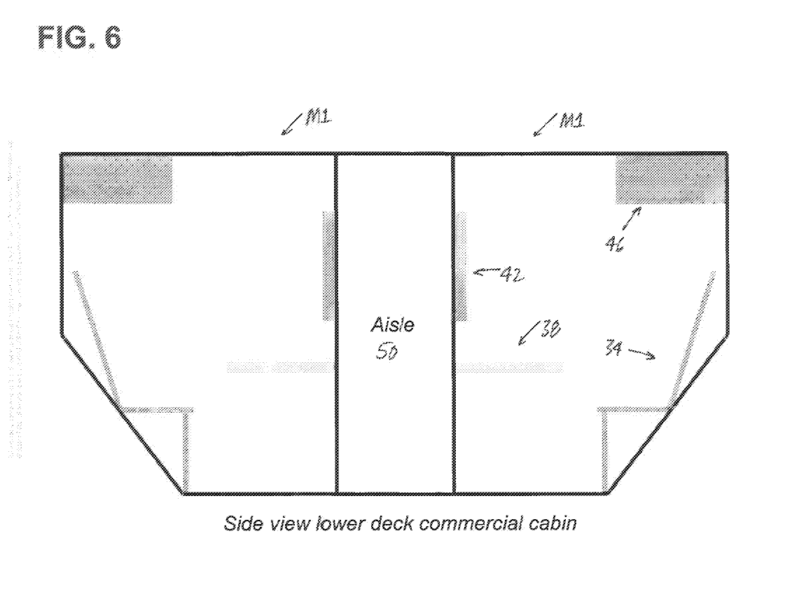

FIGS. 4-5 illustrate proposed lay-outs of shops S1 and S2, respectively, created in the lower deck cabin of the aircraft A. As non-limiting examples, the shop S1 and/or the shop S2 may have a height (H2) between seventy (70) and eighty (80) inches, and preferably approximately seventy-eight (78) inches. This height corresponds favorably to the second vertical height H2 and is sufficiently large for almost all humans to stand fully upright. Moreover, the shop S1 and/or the shop S2 may have a width between one hundred fifty (150) and one hundred seventy (170) inches, preferably approximately one hundred sixty (160) inches.

Included in either or both of shops S1 and S2 may be any or all of shelving 10, lights 14 and/or tables 18, the latter advantageously functioning as surfaces on which products may be displayed. Storage areas 22 may also be present in shops S1 and/or S2, with FIG. 4 also illustrating a surface with a cushion 26 which may be used as a seat 30.

In either or both of shops S1 and S2, passengers may examine and purchase merchandise or contract for services, potentially generating revenue for the operator of the aircraft A, the operators of shops S1 and/or S2, or both. Either or both of shops S1 and S2 may be self-service or manned with dedicated sales personnel or crew members and may include fitting rooms, for example.

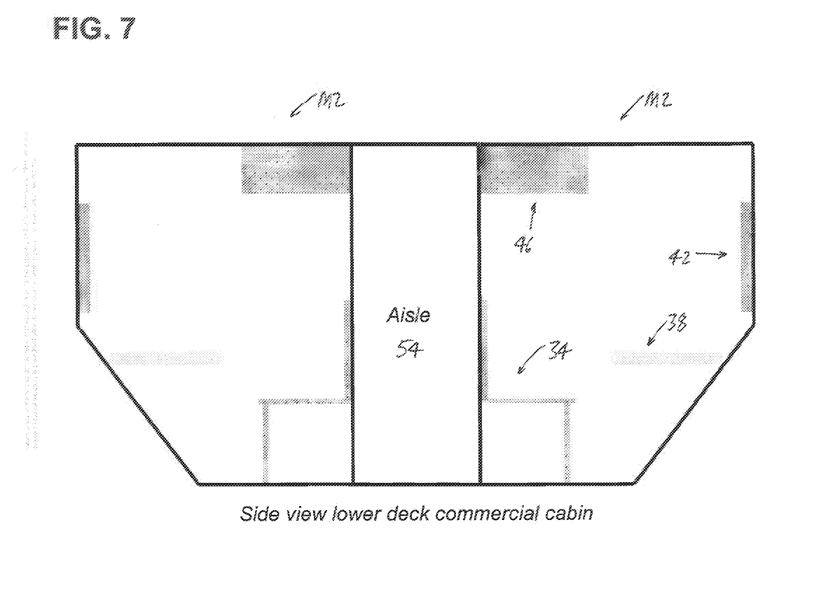

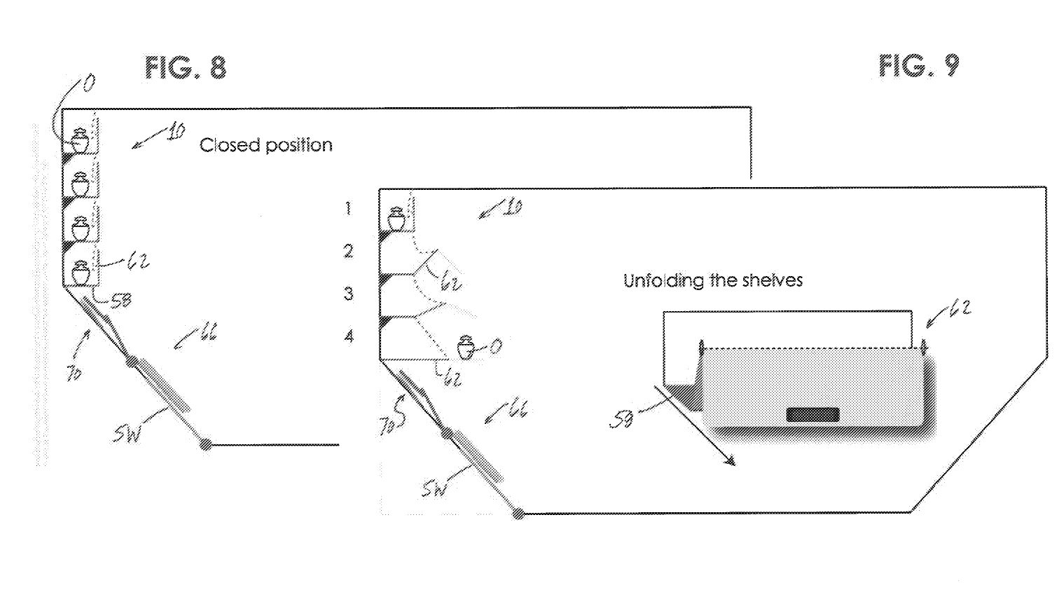

Shown in FIGS. 6-7 are respective exemplary meeting rooms M1 and M2 created in the lower deck cabin of the aircraft A. As non-limiting examples, the meeting room M1 and/or the meeting room M2 may have a height (H2) between seventy (70) and eighty (80) inches, and preferably approximately seventy-eight (78) inches. This height corresponds favorably to the second vertical height H2 and is sufficiently large for almost all humans to stand fully upright. Moreover, the meeting room M1 and/or the meeting room M2 may have a width between one hundred fifty (150) and one hundred seventy (170) inches, preferably approximately one hundred sixty (160) inches

Each of the meeting room M1 and the meeting room M2 is illustrated as having a seating arrangement 34, table 38, display 42 and/or stowage area 46. The embodiment of FIG. 6 depicts two meeting rooms M1 separated by an aisle 50 and collectively spanning the width of the lower deck cabin, while FIG. 7 depicts two meeting rooms M2 separated by an aisle 54.

Additionally, either or both of seats 30 and seating arrangements 34 may include seat belts and/or other passenger restraints. The shop S1 and/or the shop S2 and/or the meeting room M1 and/or the meeting room M2 may include emergency oxygen supplies and/or other amenities provided by PSUs.

The meeting room M1 and/or M2 may further include any or all of microphones, speakers, electronic boards, video cameras, paper reproduction equipment, power supplies, data connections, refreshments, in-flight entertainment (also designated as “IFE”) systems among other features.

Persons skilled in the art will, of course, recognize that any of the shop S1 and/or the shop S2 and/or the meeting room M1 and/or the meeting room M2 may be configured or outfitted differently than as shown and described herein.

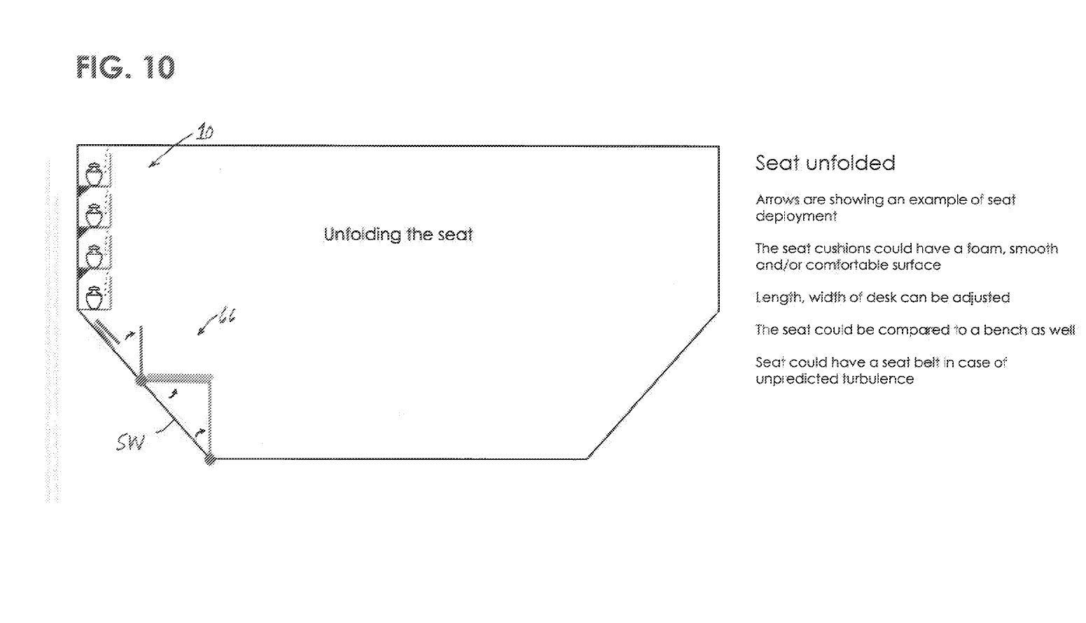

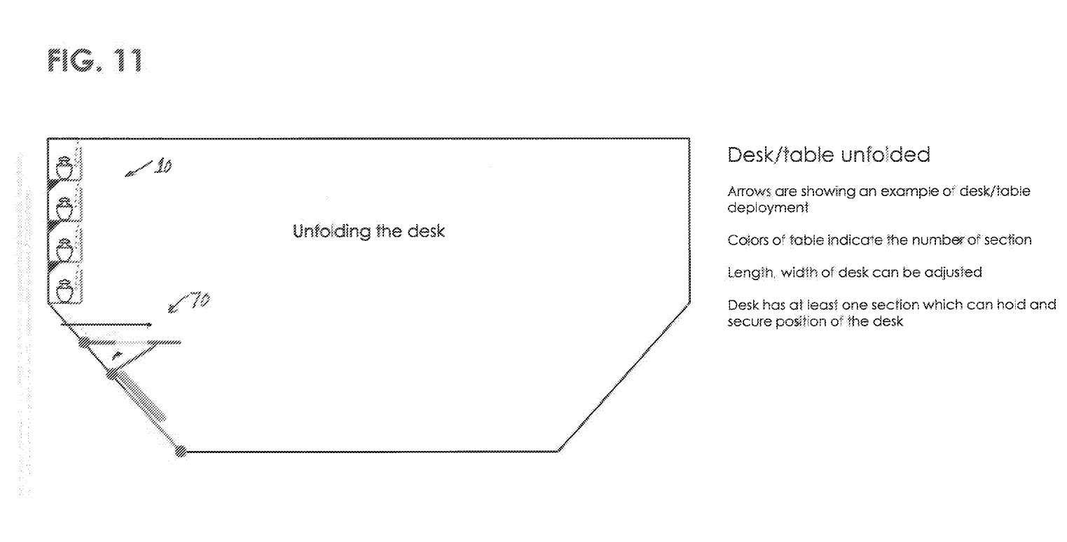

An embodiment of the shelving 10 is depicted in FIGS. 8-9. The shelving 10 may include fixed, generally horizontal supports 58 for objects O, as is conventional. However, the shelving 10 also may include hinged portions 62 moveable between at least a first position, e.g. an upright position as shown in FIG. 8, and a second position, e.g. an horizontal position as shown in FIG. 9, in which they extend the fixed portions of the supports 58. In their first position, generally vertical positions, portions 62 effectively close shelving 10 and restrain objects O therein. Closing the shelving 10 may be desirable when the aircraft A encounters turbulent conditions or is engaged in TTL phases or when the associated shop S1 and/or the associated shop S2 is itself closed to patrons. By contrast, as shown in FIG. 9, when portions 62 are moved to their second positions, thus opening shelving 10, objects O may be removed from the shelving 10 for examination and purchase.

FIGS. 8-10 also illustrate at least a seat 66 and/or a desk or table 70 available in particular embodiments of the invention. In FIGS. 8-9, the seat 66 is not in use, instead being folded against sloped wall SW. Similarly, in an unused mode, the table 70 may be folded against the sloped wall SW as shown in FIGS. 8-10.

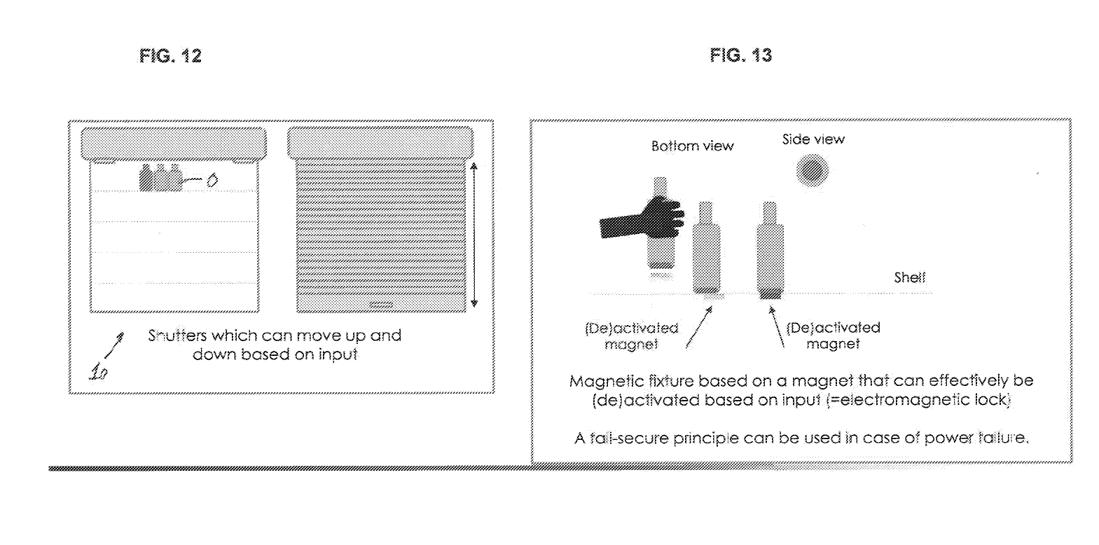

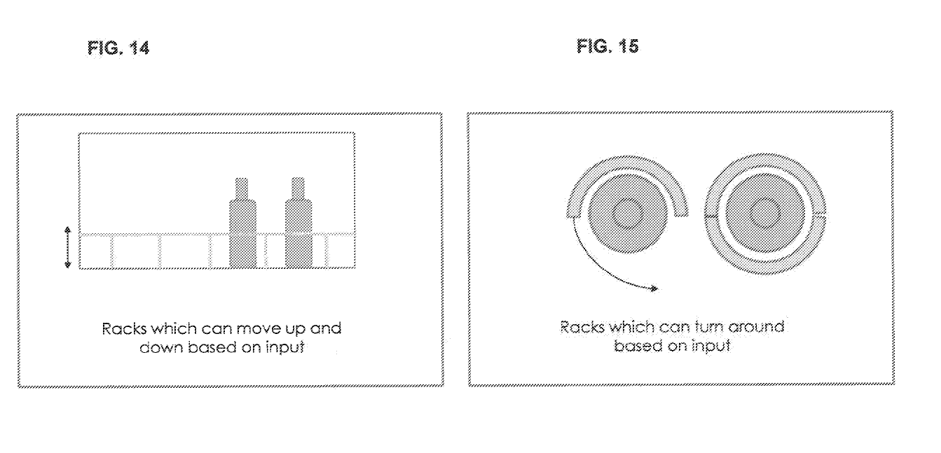

FIG. 10, however, shows the seat 66 as deployed for use, as does FIG. 11 for the table 70. Any suitable locking or latching mechanisms may be used to retain portions of the seat 66 and/or the table 70 in positions for use, following which the seat 66 and/or the table 70 may be returned to its folded position against the sloped wall SW.

Security of the lower deck cabin is important. Prevention of theft of wares available for purchase also is important. Accordingly, not only should objects O, for example, be restrained when appropriate, but they also should be restrained in a manner reducing the likelihood they could be shoplifted from the shop S1 or the shop S2. The invention thus contemplates methods and systems for automatically restraining items including objects O utilizing aircraft communications networks and equipment.

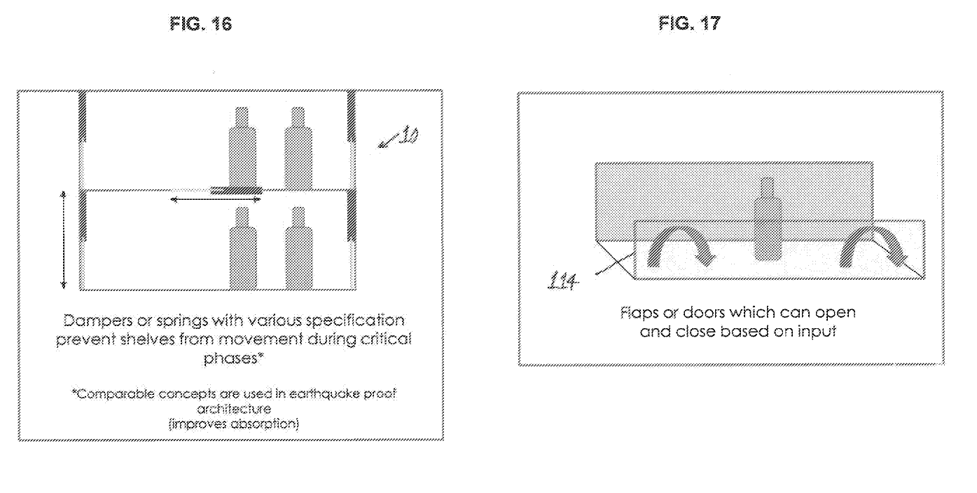

FIGS. 12-17 illustrate various restraint mechanisms for objects O, among other things, with the restraint mechanisms favorably being electrically actuatable and preferably designed to fail safe upon loss of electrical power. In FIG. 12, for example, shutters may roll or otherwise move up or down to uncover or cover objects O within the shelving 10. FIG. 13 depicts a locking system, advantageously an electromagnetic locking system, in which retaining means, for example magnets, associated with objects O may be activated and deactivated. In FIGS. 14-15, racks containing objects O may move linearly or rotate or move in both manners, generally in response to actuation signals. FIG. 16 details dampers or springs configured to limit movement of the shelving 10. And as illustrated in FIG. 17, is a flap 114 which may change position, similar to hinged portions 62, to thereby open and close the shelving 10. In at least some embodiments, a battery back-up power may be available for the actuators in the event power is not available directly from aircraft operations.

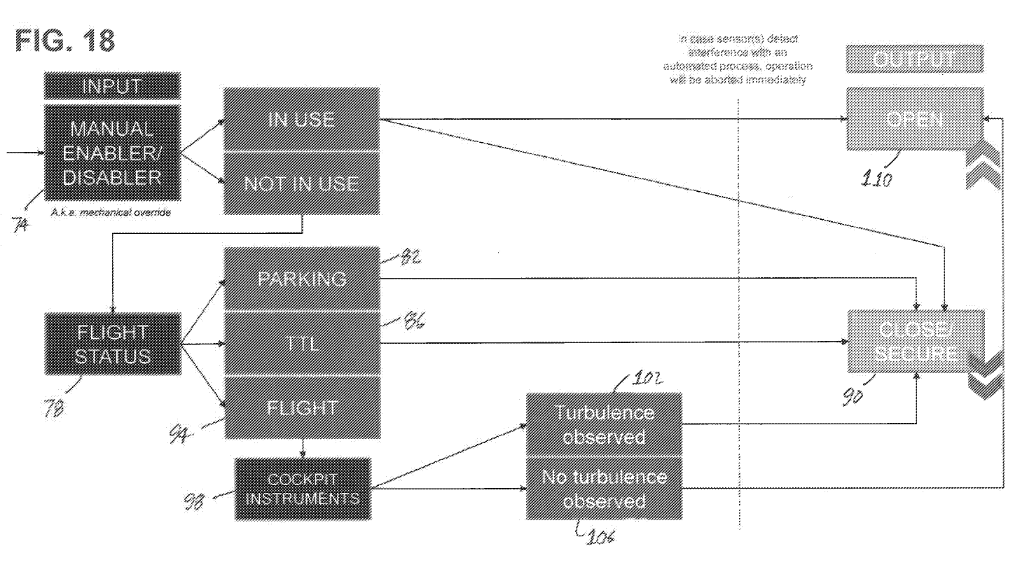

Shown in FIG. 18 is a flow chart detailing exemplary restraining decisions on-board the aircraft A. If a manual override (block 74) is not in use, systems may determine the flight status of the aircraft A (block 78). If, for example, the aircraft A is parked (block 82) or in a TTL phase (block 86), electronic actuators may be signaled to activate restraint mechanisms (block 90). By contrast, if the aircraft A is in flight (at cruise or otherwise in non-TTL phases) (block 94), cockpit instrumentation or personnel may be queried (block 98) as to whether turbulence (or some other potentially-dangerous condition) is present or, perhaps, expected. If turbulence is observed or expected (block 102), the actuators may be signaled to activate restraint mechanisms (block 90). By contrast, if no turbulence is observed or expected (block 106), the restraint mechanisms may be deactivated (block 110). Finally, if a manual override (block 74) is in use, it may signal the actuators either to activate or deactivate the restraint mechanisms. Any or all of these determinations may occur at locations remote from the lower deck cabin, thus allowing crew members to enhance security of the lower deck cabin without necessarily being present. Signals may be sent via wire or wirelessly in any appropriate manner. Sensors additionally may be employed to detect interference with activations and deactivations, for example, potentially stopping or modifying the automatic actions until safe to resume them.

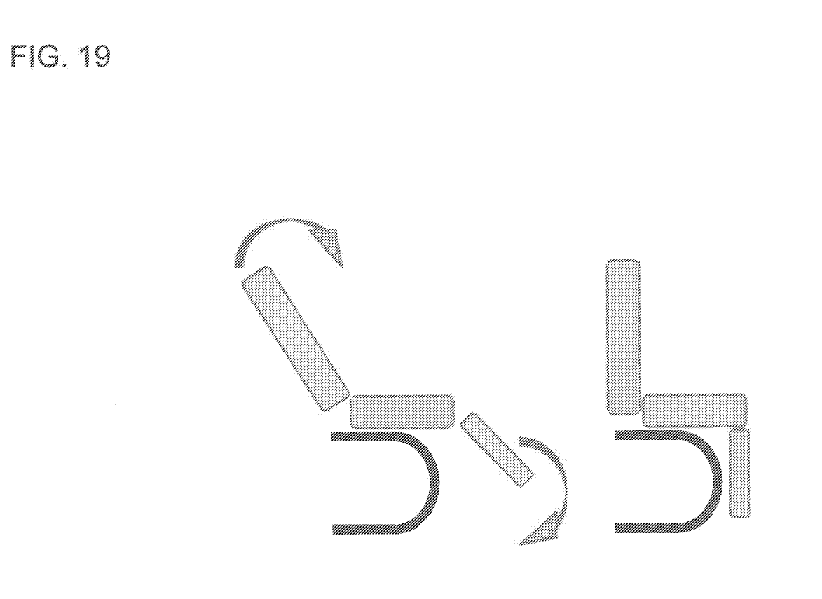

Systems consistent with FIG. 18 further could signal other electronic actuators on-board the aircraft A. As non-limiting examples, actuators could be signaled to return seats to upright or reclined positions, as shown in FIG. 19, stow and/or deploy tray tables, lock and/or unlock lavatories, overhead bins, seat belts, activate and/or deactivate cabin lighting, open and/or close window shades, open and/or close class dividers and/or curtains. Again, any of these signals may originate remote from the actuators and be conveyed by wire or wirelessly.

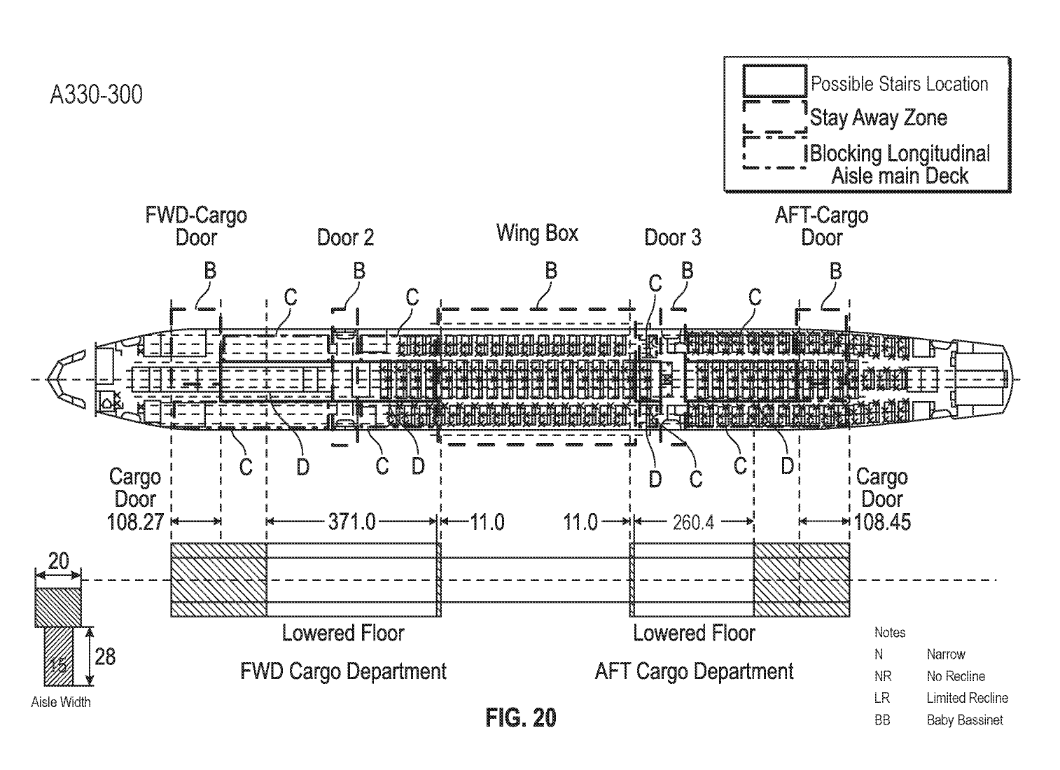

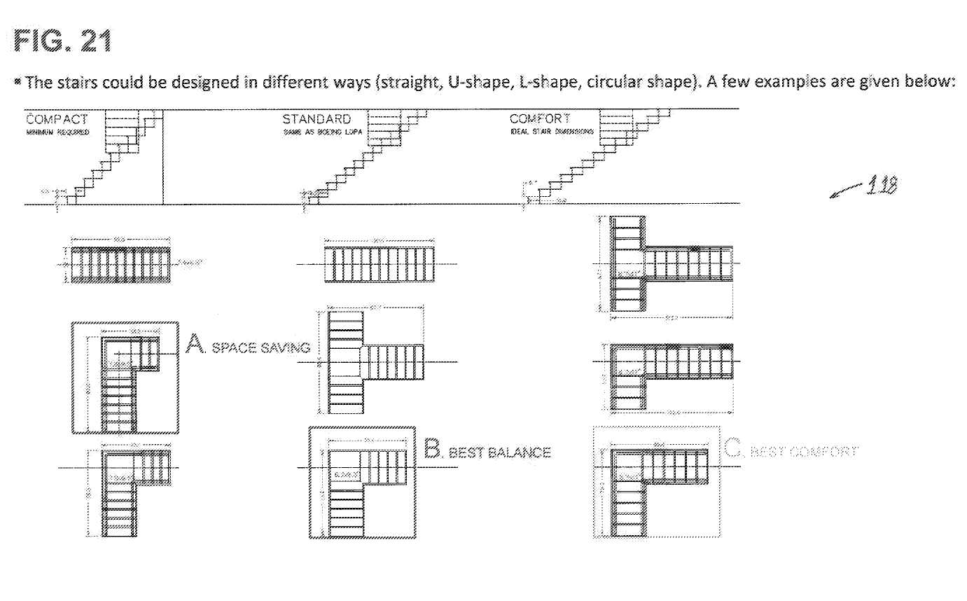

FIGS. 20-21 detail possible positioning, and aspects, of stairs 118. Advantageously, stairs 118 allow pedestrian transit of passengers between the main deck and the lower deck cabin of the aircraft A. Subject to space and other considerations, more than one set of stairs 118 may be positioned within the aircraft A if desired. Alternatively or additionally, one or more elevators, escalators and/or other means for transporting passengers between the main deck and the lower deck cabin may be used.

Depicted in FIG. 20, is a LOPA of the main deck of the aircraft A. Presently, as a particular example, the LOPA shown in FIG. 20 is of an Airbus A330-300 aircraft main deck. Principal disfavored locations for stairs 118 are shown within boxes (“B”) and include areas located:
immediately above doors D for the front cargo area FWD and/or the rear cargo area AFT,
immediately adjacent certain entrance and exit doors of the aircraft A, and/or
immediately adjacent the wingbox of the aircraft A.
   Other secondary disfavored locations for stairs 118 are shown within boxes (“C”), as they may block or impede access to longitudinal aisles of the main deck of the aircraft A.

By contrast, favored locations for stairs 118 are shown as areas “D.” In at least some instances, favored locations for stairs 118 beneficially are located vertically above the lowered floor F2 of the lower deck cabin of the aircraft A. Benefits for favored locations for stairs 118 may be achieved by placing stairs 118 in galley or lavatory areas of the main deck cabin and/or between classes of seating on-board the aircraft A. As well, benefits for favored locations for stairs 118 may be achieved by placing stairs 118 in locations likely to incent persons to visit the lower deck cabin and/or facilitate their doing so. Non-limiting examples of designs for stairs 118 are shown in FIG. 21.

The foregoing is provided for purposes of illustrating, explaining, and describing embodiments of the present invention. Modifications and adaptations to these embodiments will be apparent to those skilled in the art and may be made without departing from the scope or spirit of the invention. For example, any of the structures, systems, equipment, and objects identified herein may be modular—including, if desired, the entire lower deck cabin, an entire shop (S1 or S2) or meeting room (M1 or M2), etc. Pre-installed interfaces for water, waste, and electrical systems may be employed, for example, as may pre-installed tracks and attachment points for structures such as seats, walls, other dividers, and monuments.

Moreover, although the application relates primarily to new uses of cargo areas of a commercial passenger aircraft, concepts detailed herein alternatively may be employed on other decks or areas of passenger aircraft or on other aircraft or vehicles. The present invention thus is not limited to the embodiments here-above described and provided solely by way of example. Instead, the present invention includes all changes, different shapes and orientations, and other alternatives that may be considered within its scope and, particularly, all combinations of different embodiments previously described, which may be taken separately or together. Unless expressly designated as mutually exclusive herein, aspects of the invention may be combined and deployed in any desired combination. The contents of WO 2015/181801 also are incorporated herein in their entirety by this reference.

What is claimed is:

1. A lower deck cabin of an aircraft also comprising a main deck cabin in which commercial passengers are seated during TTL phases of flight of the aircraft, the lower deck cabin comprising:
a. a ceiling;
b. a floor having at least a portion positioned a distance from the ceiling sufficient to allow at least some commercial passengers on-board the aircraft to stand upright and move about;
c. means permitting at least some of the commercial passengers to transit to and from the main deck cabin at least when the aircraft is in flight; and
d. at least one structure with which at least some of the commercial passengers having transited from the main deck cabin may interact at least during non-TTL phases of the flight of the aircraft.

2. A lower deck cabin according to claim 1 in which the lower deck cabin is created in part either by lowering at least a portion of a technical floor of a cargo area below the main deck cabin, or by decreasing the thickness of the technical floor, so as to form the floor.

3. A lower deck cabin according to claim 1 in which the transit-permitting means comprises at least one set of stairs spanning the lower deck cabin and the main deck cabin.

4. A lower deck cabin according to claim 3 in which at least part of the at least one set of stairs is located vertically above a portion of the floor positioned a distance from the ceiling sufficient to allow at least some commercial passengers on-board the aircraft to stand upright and move about.

5. A lower deck cabin according to claim 1 in which the at least one structure comprises a shop including at least one ware available for display.

6. A lower deck cabin according to claim 5 further comprising means for restraining the at least one ware at least at times when the aircraft encounters turbulent conditions.

7. A lower deck cabin according to claim 6 in which the restraining means comprises an electronic actuator.

8. A lower deck cabin according to claim 7 in which the electronic actuator may receive an activation or deactivation signal originating from a location remote from the lower deck cabin.

9. A lower deck cabin according to claim 1 further comprising means for restraining at least the commercial passengers having transited from the main deck cabin at least at times when the aircraft encounters turbulent conditions.

10. A lower deck cabin according to claim 1 further comprising at least one wall extending between the ceiling and the floor and at least one fitting on the at least one wall, the ceiling, or the floor to which the at least one structure is attached at least when in use.

11. A lower deck cabin according to any of claim 1 in which the at least one structure comprises a meeting room or casino.

12. An aircraft comprising the lower deck cabin according to claim 1.

13. A method of converting a cargo area of a commercial passenger aircraft to a lower deck cabin, comprising:
a. lowering a floor of the cargo area such that a distance between the floor and a ceiling of the cargo area is sufficient to allow a human on-board the aircraft to stand upright on and move about the floor, thus forming a modified cargo area; and
b. configuring the modified cargo area as a lower deck cabin for use by the human during at least one non-TTL phase of flight of the aircraft by placing at least one structure, other than a seat or vending machine, in the modified cargo area with which the human may interact.

14. A method according to claim 13 in which the human is a passenger seated on a main deck of the aircraft during TTL phases of flight, further comprising providing means for permitting the passenger to transit from the main deck to the lower deck cabin during at least one non-TTL phase of flight.

15. A method according to claim 13 further comprising providing fittings in the modified cargo area to which the at least one structure may connect.

16. A method according to claim 13 in which at least one object of merchandise is contained in the structure, further comprising providing means for restraining the object during TTL phases of flight.

17. A method according to claim 13 in which the at least one structure is selected from the group of structures consisting of meeting rooms, retail shops, restaurants, casinos or gaming zones, theaters or cinemas, pet interaction areas, libraries, virtual reality areas, sports (or e-sports) venues, product presentation areas, kitchens, stowage areas, bars, clubs, or lounges, swimming pools, saunas, or spas, religious areas, gymnasiums or fitness zones, laundries, auction houses, living areas, work spaces, showers or bathrooms, pop-up stores, or other passenger accommodations.

18. An aircraft comprising:
a. a fuselage defining an interior space;
b. a partition floor dividing at least part of the interior space into (i) a main deck cabin in which at least one human is seated during TTL phases of flight of the aircraft and (ii) a lower deck area below the main deck cabin; and
c. means for allowing the at least one human to transit between the main deck cabin and the lower deck area at least when the aircraft is in flight; and
in which the lower deck area has at least a portion convertible before flight between (i) a cargo transport area and (ii) a lower deck cabin configured for use by the at least one human when the aircraft is in flight.
